(19) United States
(12) Patent Application Publication
(10) Pub. No.: US 2026/0097786 A1
(43) Pub. Date: Apr. 9, 2026

(54) SIMULATOR FOR A VEHICLE PLANNING SYSTEM

(71) Applicant: Stack AV Co., Mount Pleasant, PA (US)

(72) Inventor: William GANUCHEAU, Lafayette, LA (US)

(73) Assignee: Stack AV Co., Mount Pleasant, PA (US)

(21) Appl. No.: 18/911,037

(22) Filed: Oct. 9, 2024

(51) Int. Cl. B60W 60/00; B60W 50/06; B60W 50/14

(52) U.S. Cl. CPC B60W 60/001; B60W 50/06; B60W 50/14

(57) ABSTRACT

A method for updating a planning system of an autonomous vehicle is provided. The method comprises obtaining, at a simulator, an input comprising scene data associated with a single planning cycle of the planning system; using the simulator, apply a simulation of the planning system based on the scene data to output a plurality of autonomous vehicle metrics; updating one or more parameters of the simulation based on the plurality of autonomous vehicle metrics; outputting a plurality of updated autonomous vehicle metrics based on the one or more updated parameters; determining that a condition is satisfied based on the plurality of updated autonomous vehicle metrics; and deploying the one or more updated parameters to the planning system of the autonomous vehicle.

### FIELD

The present disclosure relates generally to autonomous and semi-autonomous vehicle planning, and more specifically to a simulator for a vehicle planning system.

### BACKGROUND

Planning systems of autonomous and semi-autonomous vehicles may determine how a vehicle meets its objectives safely and efficiently by controlling vehicle systems while responding to changing environmental conditions. A planning system may be integrated into a vehicle control architecture, taking inputs from routing, perception, and localization systems and outputting one or more decisions for low-level control systems or a driver to implement. For example, a planning system may determine how a vehicle should control its acceleration and steering as a vehicle navigates through an intersection, whether a vehicle should execute a lane change in response to surrounding highway traffic, or whether a vehicle should slow down and activate its hazard lights based on a roadway sign warning of an upcoming hazard. All of these decisions may be made by the planning system based on based on perception inputs from routing, perception, and localization systems.

Simulation systems that simulate planning systems may help vehicle engineers to troubleshoot planning system failures or errors and to assess and confirm the functionality of proposed fixes to the control logic of the planning system.

### SUMMARY

As noted above, simulation systems may simulate planning system to allow vehicle engineers to troubleshoot failures and test modifications to control logic for the planning system. However, tools designed to simulate planning systems created according to known techniques may require unreasonably large amounts of input data, for example requiring all vehicle event log data or all data associated with a relevant vehicle system. These known systems do not offer functionality to efficiently focus on the specific portions of data, specific systems, and specific portions of system that are relevant to a failure or error. For example, a simulator according to known techniques may model a vehicle perception system in addition to its planning system when addressing a failure or error limited in scope to the planning system. Additionally, known planning system simulators may simulate a multitude of planning system cycles. A planning system cycle may refer to an iterative step in which the planning system receives inputs, processes data, generates trajectories, and/or issues decisions or recommendations to enable control of the vehicle. Modeling multiple such cycles may enable simulation of the closed-loop behavior of various vehicle systems. For example, a multi-cycle simulation may model a planning system over a 30 second period, instead of limiting the cycle count or modeled duration to only the portion relevant to the failure or error. Because known systems to not offer the flexibility, efficiency, and automated logic to prevent simulation of significant amounts of unnecessary data, the runtime of such simulations may require five to ten minutes, reducing efficiency or feasibility when a user needs to run many such simulations.

Accordingly, there is a need for improved simulation systems that provide flexibility, efficiency, and automated logic to obviate the need for simulation of significant amounts of unnecessary data, thereby shortening the runtime of such simulations, increasing computational efficiency, and increasing efficiency and feasibility for running many such simulations. Disclosed herein are methods and systems that may address one or more of the above identified needs.

Described herein are methods and systems for updating a planning system of an autonomous vehicle using a simulator that models the planning system. Such simulators may enable troubleshooting of failures or errors within the planning system and/or testing of new versions of the planning system. Once a solution to the failure or a new planning system version has been validated, updated parameters associated with the solution or version may be deployed to the planning system of one or more autonomous vehicles. Unlike known planning system simulators, methods and systems disclosed herein may provide tools and capabilities for limiting (manually and/or automatically) the scope of vehicle data analyzed and/or the temporal range over which said data was captured/simulated, thereby allowing the simulation system to focus the simulation on the particular vehicle system(s) or sub-system(s) and/or on the particular temporal range relevant to the objective of the simulation. For example, the simulator may take into account only the single planning cycle relevant to an error within the planning system, and it may use as an input data from only the sub-system associated with the error. Such a limited scope model may reduce the required runtime from minutes to seconds, which may in turn significantly enhance planning system troubleshooting and software development efficiency. Disclosed herein are specific system architectures, system configurations, data processing operations, simulation system logic, and graphical user interfaces for providing said improved simulation systems having improved efficiency and usability.

The methods disclosed herein for updating planning systems using a simulator may involve first receiving, at the simulator, an input comprising scene data, for example data representing one or more inputs (e.g., from a perception system, a localization system, and/or a routing system) provided to the planning system. Scene data may be obtained in one (or more) of at least two ways. In the first case, scene data may be obtained from data extracted from an event log of a vehicle; the vehicle's planning system may generate data for the event log for each planning cycle. Extraction of event log data corresponding to an event and/or a planning cycle may be based on input from the user, indicating that an event of interest took place at a particular cycle and/or time, or may be based on automated logic, for example in response to an error being generated and/or an event (e.g., a collision) being detected. In the second case, scene data may be obtained through simulation. For example, scene data may be simulated by a scene data simulation system and/or may be obtained from data extracted from the event log of a multi-cycle simulation system. In both cases (event log extraction and scene data simulation), scene data may serve as an input for a simulation generated by the planning system simulator that may generate new simulations for only one cycle of a planning system.

The planning system simulation may model one or more aspects of the planning system control logic. For example, the simulation may model generation of a local map including one or more objects in the environment surrounding the vehicle and may be based on the scene data input. The simulation may further model planning system modules including an action generator that may be responsible for generating candidate actions for the vehicle to take in response to environmental conditions; an interaction generator responsible for modeling interactions with other dynamic roadway actors such as nearby vehicles to validate that candidate actions generated by the action generator will maintain the safety of the vehicle and nearby actors; a trajectory generator for generating candidate executable trajectories that meet the objectives of the vehicle while complying with roadways rules and maintaining safety; and a trajectory selector for selecting the most efficient and/or safest of the candidate trajectories. The simulation may further simulate planning system outputs including one or more commands for the autonomous vehicle's low-level control systems, for example, steering, throttle, and/or braking, and/or one or more recommendations for the driver of a semi-autonomous vehicle.

The simulation may output a plurality of autonomous vehicle metrics to validate an issue observed on a planning system of a physical autonomous vehicle and/or to use in regression testing of new versions of the planning system control parameters, confirming that changes implemented do not produce unintended consequences. These metrics may thus evaluate the quality of the commands and/or recommendations produced by the planning cycle simulation. For example metrics may relate to inconsistency of the vehicle's actions, controllability or safety of nearby actors, whether the vehicle is present in an efficient or ideal lane, appropriateness of right-of-way assertions by the vehicle, overall route efficiency, and/or the degree to which the vehicle kept to the lane in which it was traveling.

This plurality of metrics may be visualized on a graphical user interface for each of one or more candidate trajectories generated by the simulated planning system, allowing a user to probe the quality of candidate trajectories generated and the basis the planning system used for selecting one over the other. For example, the user interface may display the cost of selecting each trajectory which may indicate the amount by which each trajectory deviates from an ideal case for each of the above metrics.

The simulator may be run in a batch mode whereby a set of scene data may be generated and run through a single-cycle planning system simulation to generate a set of outputs. The set of scene data may represent slight variations on a particular environmental variable, for example the velocity of a proximate vehicle and/or may represent a set of standardized environmental conditions a vehicle may face. Both instances may be helpful to a user during regression testing, to understand how updated planning system control parameters perform in the face of challenging and/or typical environmental situations.

Based on the one or more visualizations generated by the graphical user interface, a user may form or validate a hypothesis on the issue a physical planning system faced and/or a way to address a bug found in a new version of control parameters. Based on this hypothesis, a user may make updates to one or more parameters of the simulation and use the simulator to apply a simulation based on the updated parameters. The user may again use the user interface to confirm that the issue has been resolved, for example by determining that a condition has been satisfied and/or that a threshold has been met based on the updated plurality of metrics. Additionally or alternatively, the simulator may itself recommend an update to address an issue a physical planning system faced and/or an error encountered while testing a new version of control parameters. The user may implement the update to the control parameters recommended by the simulator and confirm, via the user interface, that the update resolved the issue as described above. Additionally or alternatively, the simulator may itself implement the update and confirm, following a rerun of the planning system simulation that the issue has been resolved. For example, the simulator may determine that a condition has been satisfied and/or that a threshold has been met based on the updated plurality of metrics.

These updated parameters may then be deployed from a communications unit of the simulator to the communications unit of one or more autonomous vehicles that may include the type of planning system modeled by the simulator. The communications unit of the autonomous vehicle may then transfer the updated parameters to the planning system for integration, and the planning system may apply the updated parameters to control systems of the autonomous vehicle in future use cases.

In some embodiments, a method for updating a planning system of an autonomous vehicle is provided, the method comprising obtaining, at a simulator, an input comprising scene data associated with a single planning cycle of the planning system; using the simulator, apply a simulation of the planning system based on the scene data to output a plurality of autonomous vehicle metrics; updating one or more parameters of the simulation based on the plurality of autonomous vehicle metrics; outputting a plurality of updated autonomous vehicle metrics based on the one or more updated parameters; determining that a condition is satisfied based on the plurality of updated autonomous vehicle metrics; and deploying the one or more updated parameters to the planning system of the autonomous vehicle.

In some embodiments, updating the planning system comprises updating a trajectory planner of the planning system and the input comprises scene data associated with a single trajectory planning cycle of the trajectory planner. In some embodiments, the simulation of the planning system is based only on the scene data associated with the single planning cycle. In some embodiments, the planning system is configured to complete ten cycles per second. In some embodiments, the scene data associated with the single planning cycle is extracted from one or more event logs of the planning system. In some embodiments, the scene data is extracted from the one or more event logs based on at least one of a user input comprising an indication of an event or a detection by the planning system of an event. In some embodiments, the scene data comprises input data associated with the event and used by the planning system during the single planning cycle. In some embodiments, the input data comprises at least one of perception data, localization data, or routing data. In some embodiments, the perception data is detected by one or more perception sensors positioned on the autonomous vehicle. In some embodiments, the scene data associated with the single planning cycle is extracted from one or more event logs of a multi-cycle planning system simulation. In some embodiments, the scene data associated with the single planning cycle is generated by a scene data simulation. In some embodiments, generating the scene data comprises generating a plurality of variations of a scene, wherein each variation is generated based on a unique set of scene parameters. In some embodiments, the portion of the plurality of autonomous vehicle metrics comprise at least one of: one or more action inconsistency metrics, one or more actor controllability metrics, one or more lane preference metrics, one or more right-of-way assertion metrics, one or more route progress metrics, or one or more spatial lane boundary metrics. In some embodiments, determining that the condition is satisfied comprises at least one of determining, based on the plurality of updated autonomous vehicle metrics, that a failure condition has been corrected; or determining that at least one of the plurality of updated autonomous vehicle metrics meets a threshold value. In some embodiments, the single planning cycle comprises a trajectory generation step comprising generating one or more candidate trajectories based on one or more candidate actions; and a trajectory selection step comprising selecting a candidate trajectory from the one or more candidate trajectories. In some embodiments, the single planning cycle further comprises, prior to the trajectory generation step an action generation step comprising generating the one or more candidate actions for execution by the autonomous vehicle; and an interaction generation step comprising validating the one or more candidate actions based on a model of one or more interactions between the autonomous vehicle and a vehicle nearby to the autonomous vehicle.

In some embodiments, the method further comprises displaying a graphical user interface, wherein the graphical user interface comprises a visualization of at least a portion of the plurality of autonomous vehicle metrics. In some embodiments, the method further comprises detecting, at the graphical user interface, a user input indicating a selection of a selectable trajectory selection affordance; and causing, in response to detecting the user input, the graphical user interface to display at least a portion of the plurality of autonomous vehicle metrics for one or more candidate trajectories. In some embodiments, the method further comprises causing, in response to detecting the user input, the graphical user interface to display a visualization of a cost associated with the one or more candidate trajectories. In some embodiments, the cost is determined based on a difference between the autonomous vehicle metrics associated with a candidate trajectory and expected autonomous vehicle metrics. In some embodiments, the graphical user interface comprises a batch view comprising a selectable first affordance, the method further comprising:

detecting, at the graphical user interface, a user input indicating a selection of the selectable first affordance; and causing, in response to detecting the user input, the graphical user interface to display at least a portion of the plurality of autonomous vehicle metrics associated with a plurality of variations of a scene generated by a scene data simulation. In some embodiments, the portion of the plurality of autonomous vehicle metrics comprise an indication of whether each variation of the plurality of variations passed or failed a selected constraint set. In some embodiments, the portion of the plurality of autonomous vehicle metrics comprise an indication of a selected action type for each variation of the plurality of variations. In some embodiments, the batch view comprises a selectable second affordance associated with the plurality of variations, the method further comprising detecting, at the graphical user interface, a user input indicating a selection of a variation of the plurality of variations using the selectable second affordance; and causing, in response to detecting the user input, the graphical user interface to display at least a portion of the plurality of autonomous vehicle metrics associated with the selected variation.

In some embodiments, a system for updating a planning system of an autonomous vehicle is provided, the system comprising one or more processors and memory storing instructions that, when executed by the one or more processors, cause the system to obtain, at a simulator, an input comprising scene data associated with a single planning cycle of the planning system; apply, using the simulator, a simulation of the planning system based on the scene data to output a plurality of autonomous vehicle metrics; update one or more parameters of the simulation based on the plurality of autonomous vehicle metrics; output a plurality of updated autonomous vehicle metrics based on the one or more updated parameters; determine that a condition is satisfied based on the plurality of updated autonomous vehicle metrics; and deploy the one or more updated parameters to the planning system of the autonomous vehicle.

In some embodiments, a non-transitory computer readable storage medium storing instructions for updating a planning system of an autonomous vehicle is provided, wherein the instructions, when executed by one or more processors of an electronic device, cause the device to obtain, at a simulator, an input comprising scene data associated with a single planning cycle of the planning system; apply, using the simulator, a simulation of the planning system based on the scene data to output a plurality of autonomous vehicle metrics; update one or more parameters of the simulation based on the plurality of autonomous vehicle metrics; output a plurality of updated autonomous vehicle metrics based on the one or more updated parameters; determine that a condition is satisfied based on the plurality of updated autonomous vehicle metrics; and deploy the one or more updated parameters to the planning system of the autonomous vehicle.

In some embodiments, any of the features of any of the embodiments described above and/or described elsewhere herein may be combined, in whole or in part, with one another. Additional advantages will be readily apparent to those skilled in the art from the following figures and detailed description. The aspects and descriptions herein are to be regarded as illustrative in nature and not restrictive.

### BRIEF DESCRIPTION OF THE FIGURES

A better understanding of the features and advantages of the present disclosure will be obtained by reference to the following detailed description that sets forth illustrative embodiments, in which the principles of the disclosure are utilized, and the accompanying figures of which:

FIG. 1 depicts an exemplary autonomous vehicle, according to some embodiments.

FIG. 2 depicts an exemplary autonomous vehicle and simulator, according to some embodiments.

FIG. 3 depicts an exemplary process for updating a planning system of an autonomous vehicle, according to some embodiments.

FIG. 4 depicts an exemplary flowchart including systems of an autonomous vehicle, according to some embodiments.

FIG. 5 depicts a scene view of an exemplary user interface including multiple vehicle trajectory options, according to some embodiments.

FIG. 6 depicts a scene view of an exemplary user interface including multiple vehicle trajectory options, according to some embodiments.

FIG. 7 depicts a scene view of an exemplary user interface including multiple scenes, according to some embodiments.

FIG. 8 depicts an exemplary computing system, according to some embodiments.

### DETAILED DESCRIPTION

Disclosed herein are systems and methods to enable updates to the planning system of an autonomous vehicle based on a planning system simulator. The simulator may be specifically configured to optimize efficiency by processing data that is limited in scope to particular systems/subsystems and/or to particular temporal windows, rather than attempting to process an unnecessarily large or unwieldy amount of data. Specifically, the simulator system may focus on a single cycle of the planning system and/or only on data relevant to an identified planning system issue. In this manner, the planning system simulator may consider a fixed set of inputs (or may apply system logic to otherwise automatically limit the inputs that are considered) and may be appreciably more deterministic than multi-cycle simulations that may model closed-loop feedback and may receive inputs that evolve over the course of each cycle. These evolving inputs of multi-cycle simulation systems, and the differences they introduce, may result in uncertainty in the output of the multi-cycle simulation, making the result more probabilistic and less repeatable. Given these added complexities, a multi-cycle simulation modeling 30 seconds of planning system operation may take up to ten minutes to complete, which may significantly increase issue resolution and/or software development time. By instead providing a system that provides for effective and efficient modeling of only a single planning cycle of a planning system, ten of which may take place per second, the planning system simulator may quickly and repeatably recreate the logic a planning system used or may use in the future to output a set of decisions and/or driver recommendations, reducing simulation time from minutes to seconds.

The ability to model only a single planning cycle may be enabled by use of a planning system that, for every cycle, generates an event log that may contain inputs used by the planning system, weightings and other control parameters, the state of one or more relevant vehicle systems, and/or the outputs the planning system generated in the form of commands for low-level vehicle systems and/or recommendations for semi-autonomous vehicle drivers. The planning system event log may thus include a record of past inputs and a projection of future inputs on which the planning system may use for example to generate candidate trajectories and/or select a trajectory to follow from amongst the candidate trajectories. Event log data from the most recent past cycle may thus form an input for the planning system during the subsequent cycle.

Event log data associated with an event of interest may be extracted from the event log of the most recent past cycle and the present cycle. This extracted event log data may form a scene data input to the planning system simulation. Alternatively, scene data may be simulated or extracted from the event log of a multi-cycle simulation. The planning system simulator may generate a single-cycle simulation that models various modules used for example to generate and select a vehicle trajectory as well as associated outputs for low-level vehicle systems or semi-autonomous vehicle drivers.

The system may also output a plurality of autonomous vehicle metrics that allow a user to understand the control logic and decision-making of the modeled planning system. This control logic may be involved in, for example, generating candidate trajectories and/or selecting an optimal trajectory from among the candidates. These metrics may be combined and visualized in a user interface that allows a user to triage or troubleshoot issues observed in a physical planning system and/or to conduct regression testing on the latest version of planning system control parameters. In the latter case, the user interface may be used in a batch mode that allows comparison of multiple different scene data inputs, whether they represent slight variations of a single variable or a standardized set of test cases. Such comparisons may allow a user to quickly gauge whether a proposed solution or an upgraded version of control parameters meets a defined standard and doesn't produce any untended effect. Additionally or alternatively, the simulator itself may generate a recommendation or solution to an issue in the form of an updated set of control parameters, and optionally implement the update and confirm that it resolved the issue. Once an updated set of parameters are determined to resolve an issue and/or to function as intended, the updated parameters may be deployed to the planning systems of one or more autonomous vehicles, and may be used thereafter by the vehicles to control navigation systems and other systems of the vehicles.

In the following description of the various embodiments, it is to be understood that the singular forms “a,” “an,” and “the” used in the following description are intended to include the plural forms as well, unless the context clearly indicates otherwise. It is also to be understood that the term “and/or” as used herein refers to and encompasses any and all possible combinations of one or more of the associated listed terms. It is further to be understood that the terms “includes,” “including,” “comprises,” and/or “comprising,” when used herein, specify the presence of stated features, integers, steps, operations, elements, components, and/or units but do not preclude the presence or addition of one or more other features, integers, steps, operations, elements, components, units, and/or groups thereof.

Certain aspects of the present disclosure include process steps and instructions described herein in the form of an algorithm. It should be noted that the process steps and instructions of the present disclosure could be embodied in software, firmware, or hardware and, when embodied in software, could be downloaded to reside on and be operated from different platforms used by a variety of operating systems. Unless specifically stated otherwise as apparent from the following discussion, it is appreciated that, throughout the description, discussions utilizing terms such as “processing,” “computing,” “calculating,” “determining,” “displaying,” “generating” or the like, refer to the action and processes of a computer system, or similar electronic computing device, that manipulates and transforms data represented as physical (electronic) quantities within the computer system memories or registers or other such information storage, transmission, or display devices.

The present disclosure in some embodiments also relates to a device for performing the operations herein. This device may be specially constructed for the required purposes, or it may comprise a general-purpose computer selectively activated or reconfigured by a computer program stored in the computer. Such a computer program may be stored in a non-transitory, storage medium, such as, but not limited to, any type of disk, including floppy disks, USB flash drives, external hard drives, optical disks, CD-ROMs, magneto-optical disks, read-only memories (ROMs), random access memories (RAMs), EPROMs, EEPROMs, magnetic or optical cards, application-specific integrated circuits (ASICs), or any type of media suitable for storing electronic instructions, and each connected to a computer system bus. Furthermore, the computing systems referred to in the specification may include a single processor or may be architectures employing multiple processor designs, such as for performing different functions or for increased computing capability. Suitable processors include central processing units (CPUs), graphical processing units (GPUs), field programmable gate arrays (FPGAs), and ASICs.

The methods, devices, and systems described herein are not inherently related to any particular computer or other apparatus. Various general-purpose systems may also be used with programs in accordance with the teachings herein, or it may prove convenient to construct a more specialized apparatus to perform the required method steps. The structure for a variety of these systems will appear in the description below. In addition, the present invention is not described with reference to any particular programming language. It will be appreciated that a variety of programming languages may be used to implement the teachings of the present disclosure as described herein.

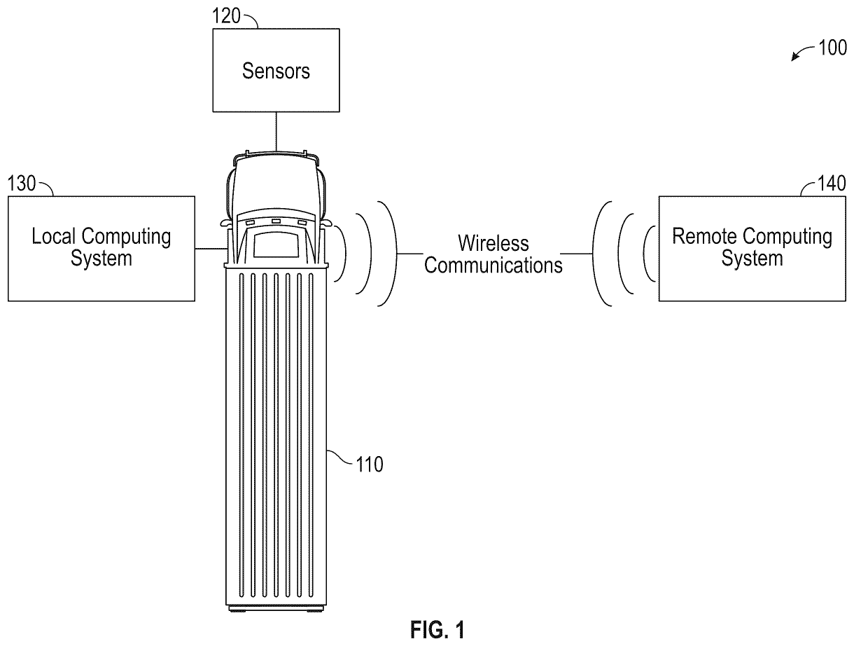

FIG. 1 depicts a system 100 that includes an autonomous vehicle along with associated sensors and computing systems. Specifically, system 100 may include an autonomous or semi-autonomous vehicle 110, a local computing system 130, one or more sensors 120, and a remote computing system 140. Autonomous or semi-autonomous vehicle 110 may include, for example, a passenger vehicle, a van, and/or a semi-truck with a vehicle control system including some degree of autonomous control and/or driver assistance. Vehicle 110 may include one or more vehicle systems dedicated to one or more assemblies or functions including, for example, powertrain, steering, suspension, braking, lighting, and fuel injection. Additional systems of vehicle 110 may be devoted to sensing the environment around the vehicle to assist the vehicle's semi-autonomous or autonomous features. For example, vehicle 110 may include sensors 120 that may be associated with perception, localization, and/or routing systems of vehicle 110, responsible for detecting the environment surrounding the vehicle, localizing the vehicle on a map, and generating a navigational route for the vehicle to follow. For example, sensors 120 may include one or more perception sensors, such as optical sensors with or without a wide field-of-view, and/or LiDAR sensors; and/or one or more localization sensors such as a GPS receiver and/or IMU sensor, that may provide inputs to an autonomous or semi-autonomous driving system of the vehicle.

Local computing system 130 may include computing units with processors and memory to process data from one or more of the above-described vehicle systems. Specifically, local computing system 130 may include a planning system that receives inputs from, for example, the perception, localization, and/or routing systems of vehicle 110 and may generate one or more outputs such as actions, interactions, and/or selected or generated vehicle trajectories. These one or more outputs may then be received by one or more control systems of vehicle 110 and used to inform the vehicle's motion and/or interaction with its environment. Alternatively or additionally, the one or more control systems may produce a message recommending a driver execute one or more actions based on the one or more outputs. For example, if a routing system of an autonomous vehicle detects an upcoming road closure and creates an input for the planning system representing two or more possible detours the vehicle may take, the planning system may compare the costs associated with each route, for example amount of time added to the route and the required volume of additional fuel consumed based on the topography and speed limits of each route. This cost comparison may form part of the planning systems basis for choosing one route over the other, and providing as an output to one or more control systems a trajectory necessary to enact the selected route and/or directions to a driver to follow the selected route.

The planning system of local computing system 130 may execute on a cyclic basis. As used herein, a planning system cycle may refer to an iterative step in which the planning system stores provided inputs and/or the state of one or more vehicle systems in an event log and generates one or more decisions or other outputs at a particular planning cycle frequency, for example ten times every second. This frequency may be faster, for example 20 times, 30 times, 40 times, 50 times, 80 times, and/or 100 times every second. The planning cycle frequency may also be slower, for example 1 time, 2 times, 3 times, 4 times, and/or 5 times every second. This event log may be stored on local computing system 130 and/or may be stored on a computing system remotely connected to local computing system 130, for example remote computing system 140. Local computing system 130 may communicate with remote computing system 140 using one or more communication units wireless connected to one or more communication units in remote computing system 140, thereby enabling the transfer of event logs and/or other relevant vehicle data.

Remote computing system 140 may also include a simulator used to simulate the planning system in local computing system 130. The simulator may use scene data, or data representing the inputs provided to the planning system and/or the state of one or more vehicle systems for each planning cycle of the planning system, as the basis for simulating the planning system. This scene data may be based on event log data stored on local computing system 130 and/or remote computing system 140. Alternatively or additionally, as discussed below, scene data used by the simulator may be generated by a scene data simulation that may be integrated into the planning system. The planning system simulator may be used to troubleshoot issues with the vehicle's planning system, including by running a selected or simulated planning cycle again with a different set of control parameters, and/or may be used to test a new version of the planning system. Once the updated parameters that correspond to a fix of a planning system problem or to a new version of the planning system have been validated, the updated parameters may be deployed to the planning system by transmitting them wirelessly from remote computing system 140 to local computing system 130.

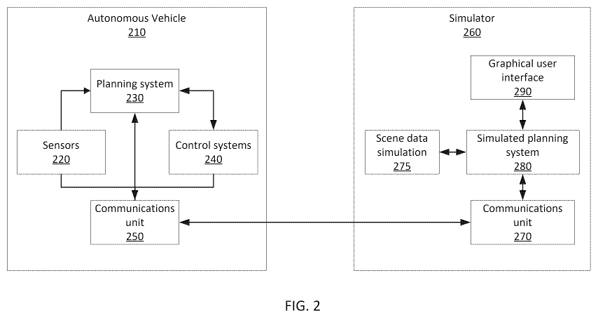

FIG. 2 depicts an exemplary autonomous vehicle 210 and a simulator 260 in communication with autonomous vehicle 210. As discussed above, autonomous vehicle 210 may include sensors 220, for example one or more optical sensors, LiDAR sensors, GPS receivers, and/or IMU sensors. These sensors may inform systems used by the vehicle to enable autonomous or semi-autonomous driving including, for example, perception, localization, and/or routing systems. Information from sensors 220 may be used by planning system 230 of vehicle 210 as an input to inform one or more decisions about how the vehicle should respond to detected changes in its immediate environment and/or upcoming roadway conditions. Planning system 230 may provide such outputs and decisions to one or more vehicle control systems 240 that determine the vehicle's motion and response to environmental conditions. The state of control systems 240 may also serve as an input to planning system 230.

For example, if an optical sensor of the vehicle's perception system detects a vehicle braking immediately in front of vehicle 210, planning system 230 may use this detection input to determine that the vehicle must immediately reduce its speed. However, one or more control systems 240 may notify planning system 230 that the braking system of the vehicle is already applying the maximum braking force. In such a case, planning system 230 may take the input from sensors 220 and from control systems 240 and determine that the maintain vehicle safety, a lane change is required. Accordingly, planning system 230 may generate an output for a separate control system, for example, the control system associated with steering, causing vehicle 210 to change to an adjacent lane thereby avoiding the braking vehicle in front of vehicle 210.

Sensors 220, planning system 230, and control systems 240 may each be in communication with communication unit 250 of autonomous vehicle 210. For example, communication unit 250 may receive from planning system 230 event log data that may include signals representing planning system inputs and/or the state of one or more vehicle systems recorded at a particular planning cycle frequency. Communication unit 250 may in turn be communicatively coupled to a communication unit 270 of a simulator 260 whose purpose may be to generate and/or utilize a simulation of planning system 230 and/or similar planning systems. For example, communication unit 270 may receive event log data from communication unit 250 that may include a series of a planning cycles executed by planning system 230. A user may then provide simulator 260 an input by selecting a particular event, a particular point in time, and/or a particular planning cycle that corresponds to an issue warranting simulation and/or troubleshooting by simulator 260. Such an input may serve as a basis for simulator 260 to extract event log data associated with an event of interest.

For example, simulator 260 may extract event log data corresponding to a single planning cycle of interest and may extract only a segment of data of the single planning cycle that is most relevant to an issue that arose during operation of planning system 230. For example, if planning system 230 failed to command the steering system of vehicle 210 to change to a turning lane in advance of turn advised by the routing system and confirmed by the planning system, simulator 260 may extract event log data corresponding to the planning cycle associated with the decision to remain in the present lane and not enter the turning lane. Further, simulator 260 may extract only event log data associated with the selected planning cycle that is pertinent to this routing decision. The extracted event log data may optionally be at least partially based on event log data from the most recent past cycle in addition to the present cycle. This may ensure vehicle system signals are tracked over time, thereby improving continuity of planning system decisions and reducing the need for a multi-cycle simulation to capture signal evolutions. This extracted event log data may then be used to form a scene data input for simulated planning system 280, a model of planning system 230. Alternatively, scene data may be simulated by a scene data simulation 275 that may be part of simulator 260. As discussed below, by providing simulated planning system 280 a scene data input that is limited in scope, the requisite runtime and variability of the simulation may be reduced thereby improving simulation and troubleshooting efficiency.

As described in further detail below, simulated planning system may then be used to troubleshoot an issue with planning system 230 and/or test out a new version of the planning system. To troubleshoot, simulated planning system may first simulate the planning system based on the scene data input to confirm or validate the issue with planning system 230. The user may then test different planning system parameter configurations to attempt to resolve the issue. To assist in evaluating whether the issue has been resolved, simulator 260 may generate a graphical user interface 290 including outputs from simulated planning system 280, for example one or more relevant autonomous vehicle metrics that may have changed based on the change in planning system parameter configuration. In the above example, vehicle lane occupation may be one such metric visualized using graphical user interface 290 as a function of one or more planning system parameter configurations. The user may use graphical user interface 290 to determine and provide simulator 260 confirmation that the issue has been resolved satisfactorily. Additionally or alternatively, simulator 260 may automatically detect that an update to planning system parameters has resolved the issue. During instances in which simulator 260 is used to test new versions of planning system parameters, determining that the output is satisfactory may in fact result in the user and/or simulator 260 determining that certain relevant autonomous vehicle metrics are sufficiently similar to values corresponding to previous parameter versions, while other values have been sufficiently improved.

Once autonomous vehicle metrics relevant to the simulation indicate the objective of the simulation has been achieved, the updated planning system parameters may be deployed to planning system 230 by transmitting the parameters from simulated planning system 280 to communication unit 270, from communication unit 270 to communication unit 250, and finally from communication unit 250 to planning system 230.

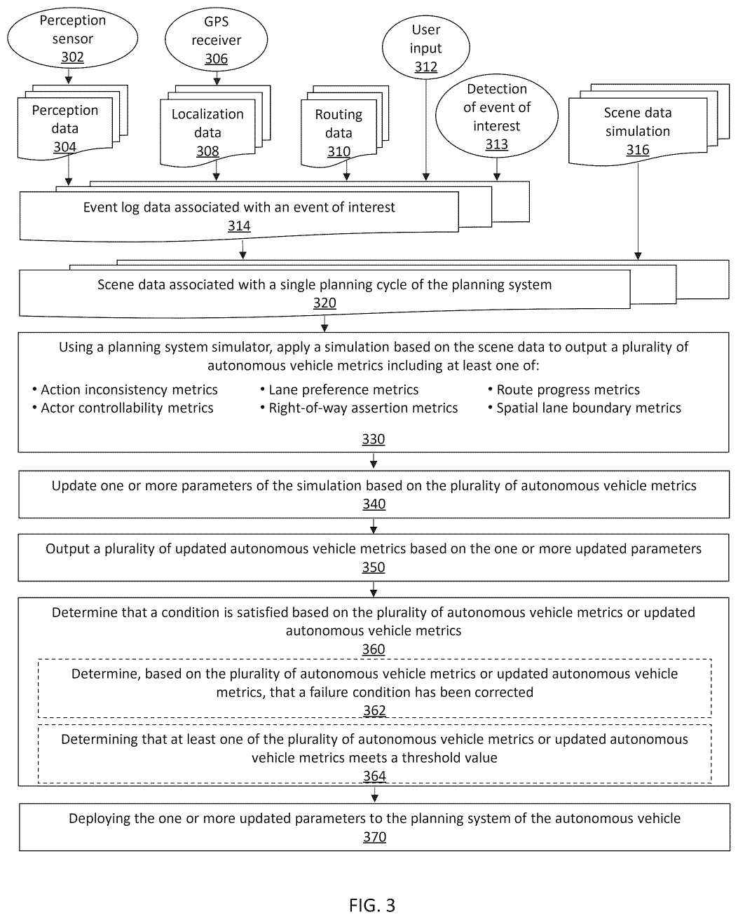

FIG. 3 depicts an exemplary process for updating a planning system of an autonomous vehicle using a planning system simulator. As discussed above, scene data 320 associated with a planning cycle of the planning system may represent planning system inputs and/or the state of the vehicle, including signals associated with one or more vehicle systems, at a particular point in time. Scene data 320 may be obtained by one or more routes, including at least (1) extracting event log data 314 that may be associated with an event of interest from the planning system of a physical vehicle, and/or (2) using a scene data simulation to generate simulated planning system data.

Event log data used to obtain scene data 320 via the first route may itself be generated based on inputs from one or more vehicle systems. Event log data may represent a record of events and actions that occurred in an autonomous vehicle system, including the messages exchanged between various vehicle systems, records of completed tasks, and any errors that occurred in the process. This data may include inputs provided to the planning system by other vehicle systems. For example, entries of event log data may include “at 14:07:31.100, the perception system provided the planning system a vehicle proximity warning” and “at 14:07:31.200, the planning system commanded the braking system to engage the brakes at 33% for the next three seconds.” Thus, event log data may represent an index of messages or data packets exchanged between various vehicle systems, including between the planning system and the perception system, localization system, and/or routing system, and/or between the planning system and the one or more control systems of the vehicle. Accordingly, exemplary sources of event log data may include perception data 304, localization data 308, and routing data 310. These data sources may in turn have been generated by one or more sensors including, for example, perception sensor 302 (e.g., an optical sensor with or without a wide field-of-view, and/or a LiDAR sensor) used to generate perception data 304, and GPS receiver 306 and/or a motion sensor such as an IMU sensor used to generate localization data 308.

A user-provided input 312 may be used to extract event log data 314 associated with an event of interest and corresponding to a lower temporal range or data size. Input 312 may be generated by a user who selects a particular event, a particular point in time, and/or a particular planning cycle of the planning system that corresponds to an issue warranting simulation and/or troubleshooting by the simulator. For example, a user may note the identification number associated with a particular event or a particular index of a planning cycle, and provide this identification number as input 312. Alternatively or additionally, the planning system and/or an associated autonomous vehicle system may detect, based on event log data and/or other vehicle data, that a failure, error, or other event that may warrant investigation has occurred and may isolate a portion of event log data based on the time an unusual event occurred and/or based on the systems or sub-systems related to the unusual event. Thus, based user input 312 and/or detection of an irregular event 313, event log data 314, associated with an event of interest, may be extracted.

Such unusual events or events of interest may include situations in which the planning system received inaccurate information or an insufficient amount of information necessary to make a decision, for example the routing system may not have had access to the latest roadway closure notifications and thereby was not able to provide such information to the planning system to use in validating the navigational route taken by the vehicle. Other events of interest may result from a failure of the control logic used by the planning system, for example the planning system may have interpreted an elongated “turn only” arrow painted onto a lane as a “straight only” arrow, thereby forcing the vehicle's autonomous driving system or human driver to make a last-minute correction at an intersection to maintain the safety of the vehicle and surrounding drivers, adding time to the route.

As mentioned above, the second route for obtaining scene data may involve generating it using a scene data simulation 316. Such a scene data simulation may be integrated into the planning system simulator to enable iterative problem solving. Scene data simulation 316 may generate scene data associated with a single planning cycle. That is, simulation 316 may generate the planning system inputs and/or vehicle systems states that would have been recorded in an event log of an autonomous vehicle exposed to a particular set of inputs during a single cycle of the vehicle's planning system. Scene data simulation 316 may generate scenes by generating files written in computing languages such as Python and/or C++. Scene data simulation 316 may also integrate with software, such as TestMap and/or CARLA, that may create custom environments and local maps to simulate the environment an autonomous vehicle may experience.

Alternatively or additionally, scene data simulation 316 may generate two or more variations on a scene that an autonomous vehicle may face, each based on a unique set of scene parameters. For example, variations could include the autonomous vehicle's velocity approaching an intersection, where each variation is an incrementally different velocity, for example, 18 MPH, 20 MPH, 22 MPH, and/or 24 MPH. Variations may also include the number of vehicles proximate to the autonomous vehicle and/or indications of driver behavior, for example use or non-use of turning signals. Alternatively or additionally, variations may encompass a range of scenarios an autonomous vehicle may typically face, to allow a user to set expectations and measure the response of the latest version of the planning system to standard scenarios. Each variation may thus correspond to a different instance of scene data that serves as an input to the single-cycle planning system simulation and may involve running the simulation multiple times in a batching operation, once for each variation.

For example, variations numbering in the hundreds may be generated and represent slightly different parametrizations of a scene. Studying such a large number of variations may ensure a planning system isn't overfitted to a specific scene type or set of environmental conditions. This may be useful when diagnosing and testing for subtle bugs and/or regressions in the planning system control logic that may appear only in edge cases. Such regression testing in turn may inform continuous integration processes to set expectations and build confidence in the stability and/or reliability of a new version or update to planning system control parameters.

Additionally, with scene data of each variation optionally limited to correspond to a single planning cycle, the amount of data simulated and thus requisite runtime may be relatively low, enabling simulating of a plurality of variations in a short period of time. As discussed below, modeling variations in this manner may enable a user to visualize in a graphical user interface the effect of different parameters, for example vehicle velocity, on various autonomous vehicle outcome metrics, for example whether a collision takes place.

Separate planning system simulations that may be based on multiple planning cycles may generate simulated event logs as a physical planning system running over multiple cycles might and may include simulated event log data associated with the multi-cycle planning system simulation. In such cases, simulated scene data may be obtained by extracting event log data from the simulated event log much in the same way event log data may be extracted from an event log of a physical planning system. Namely, a user may provide an input indicating a portion or planning cycle of the event log corresponding to an event of interest, and/or the multi-cycle planning system simulation may detect such an event, with one or both of these inputs enabling extraction of simulated event log data that may form simulated scene data for input to the planning system simulator at step 330.

Thus, scene data 320 may be obtained from extracted event log data 314 associated with an event of interest, generated using a scene data simulation 316, and/or extracted from a simulated event log of a multi-cycle planning system simulation. Scene data 320 may represent the inputs received by a physical or simulated planning system of an autonomous vehicle and/or the states of one or more vehicle systems corresponding to a single planning cycle. As mentioned above, an autonomous vehicle planning system may operate on a cyclic basis with inputs received and outputs or decisions generated at a particular frequency, for example 5, 10, or 25 cycles per second. By using as an input scene data 320 corresponding to a single planning cycle of the planning system, the planning system simulation may be more deterministic as compared to simulations that model multiple planning cycles. This is because a single cycle model may involve a fixed set of inputs, environmental conditions, and/or system states, evaluated at a fixed point in time, factors which may improve output repeatability. Multi-cycle simulations by contrast may receive inputs that may evolve over each subsequent cycle. Small differences introduced during each cycle may cumulatively result in shifts in outputs from one simulation to the next, which may in turn make such multi-cycle simulations less deterministic and more probabilistic.

This deterministic, limited nature of a single cycle-based planning cycle simulator may improve a user's ability to use the simulator as debugging tool, making it easier to determine the root cause of a failure, error, and/or event of interest and/or to determine the effect of a new set control parameters. By isolating a singled cycle, a user may more easily analyze a complex environmental scenario or edge case such as a drastic lane change reduction and/or an accident to test how the planning system responds to such situations. A single cycle-based planning cycle simulator may also enable faster computation and lower computational overhead, reducing requisite runtime from minutes to seconds, and enabling faster iterations. Instead of a multi-cycle simulation with varying inputs, as mentioned above, the planning system simulator may run multiple single-cycle simulations based on variations in scene data, thereby enabling study, for example, of the effect that variation of one input parameter has on the output.

At step 330, the planning system simulator may apply a single-cycle simulation based on scene data 320. The simulation may thus recreate/replay or create for the first time a scenario that a physical planning system has in the past or may in the future face: the simulation may take a fixed set of inputs from vehicle systems such as the perception, localization, and/or routing and may apply control logic based on planning system control parameters. As described below in further detail, this may entail modeling generation of a local map that may include environmental objects surrounding the vehicle and may be based on the scene data input. The simulation may further model planning system modules including an action generator that may be responsible for generating candidate actions for the vehicle to take in response to environmental conditions; an interaction generator responsible for modeling interactions with other dynamic roadway actors such as nearby vehicles to validate that candidate actions generated by the action generator will maintain the safety of the vehicle and nearby actors; a trajectory generator for generating candidate executable trajectories that meet the objectives of the vehicle while complying with roadways rules and maintaining safety; and a trajectory selector for selecting the most efficient and/or safest of the candidate trajectories.

Running the above modeling operations to replay the scene may additionally involve outputting a set of one or more decisions that, in the autonomous vehicle context, may command one or more low-level vehicle control systems including, for example, steering, acceleration, braking, and/or lighting, to implement a particular change in vehicle operation, for example “rotate the steering wheel by 5% to the left for two seconds.” In the semi-autonomous vehicle context, these one or more decisions may additionally or alternatively take the form of recommendations to the driver to implement the changes in vehicle operation. The planning system simulation may additionally output a plurality of autonomous vehicle metrics. These metrics, listed below, may indicate to what degree the decisions, whether they are control system commands or driver recommendations, meet various vehicle control and operational standards.

Such autonomous vehicle metrics may include action inconsistency metrics, actor controllability metrics, lane preference metrics, right-of-way assertion metrics, route progress metrics, and/or spatial lane boundary metrics. Action inconsistency metrics may indicate to what degree the planning system decision or output would result in operation of the vehicle in a smooth manner, producing driving that may be predicted by other drivers and roadway actors. Actor controllability metrics may indicate to what degree the planning system output would induce a reaction and/or response in other roadway actors and/or to what degree the planning system output would minimize the risk of a sudden maneuver by the other actors. Lane preference metrics may indicate to what degree the planning system output would result in the vehicle preferring and occupying a lane that is the most efficient for navigational purposes and the safest given rules of the road and proximate vehicles. Right-of-way assertion metrics may indicate to what degree the planning system output would result in the vehicle asserting its right-of-way without unduly increasing the risk of a collision and/or another unsafe situation. Route progress metrics may indicate to what degree the planning system output would result in the vehicle following an efficient route corresponding to a minimal driving time. Spatial lane boundary metrics may indicate to what degree the planning system output would result in the vehicle remaining within the boundaries of a specified lane.

At step 330, a user may thus evaluate one or more of the above autonomous vehicle metrics to troubleshoot an identified issue in the case of scene data originating from a event log data of a physical planning system and/or to determine whether the simulated planning system responded appropriately to simulation-derived scene data. In the event the user is confirming a new version of planning system control parameters operates as expected, the user may skip to step 360 to determine whether a condition is satisfied based on the autonomous vehicle metrics. In the event the user is troubleshooting an issue that, for example, was originally identified by the user as an input 312 or detected by the planning system and/or a separate vehicle system as detection 313, the user may confirm the simulated planning system has reproduced the issue, possibly by evaluating one or more of the autonomous vehicle metrics and/or one or more different performance conditions. For example, a user may identify the planning cycle corresponding to a physical vehicle unexpectedly crossing one of the lane lines of the lane along which it is traveling. The user may then use the simulator to apply a simulation of the planning cycle and confirm that the simulated planning system has also commanded the vehicle to cross the lane line.

The user may choose to investigate further to determine whether the deviation was based on a faulty input provided to the planning system or faulty planning system control logic. If the cause was a faulty input, for example a defect in a perception system detection causing the perception system to believe a vehicle was immediately proximate to the autonomous vehicle when in reality there was a lane separating the two vehicles, the user may turn to the system providing the faulty input for further debugging. If the cause was determined to be internal to the planning system, the user may make a hypothesis as to its cause, for example by changing one or more weightings or scaling factors used by the planning system. For example, if a vehicle is overly assertive of its right-of-way, increasing risk of injury or damage to nearby roadway actors, a user may hypothesize that right-of-way assertion is too heavily weighted in the current configuration of planning system control parameters. The user may then, at step 340, modify one or more planning system control parameters based on the hypothesis and update the one or more parameters of the planning system simulation to reflect these modified parameters. At step 350, the user may use the planning system simulator to again apply the simulation based on the scene data, and output a plurality of updated autonomous vehicle metrics based on the one or more update parameters.

Next, at step 360, the user may evaluate whether the updated control parameters of the planning system caused the simulation to correct the targeted issue or otherwise produce acceptable and expectable decisions. In the case in which the simulation was run using original or un-updated control parameters, step 360 may involve determining that a condition is satisfied based on the plurality of original autonomous vehicle metrics. To make such a determination, a user may evaluate at step 362 whether a failure condition has been corrected, based on the original or updated autonomous vehicle metrics. In the above example, this could involve determining that the vehicle is no longer asserting its right-of-way in a way that unacceptably increases the risk of injury or damage to nearby roadway actors. Additionally or alternatively, a user may evaluate at step 364 whether the original or updated autonomous vehicle metrics meet a threshold value. In the above example, this may involve a metric corresponding to roadway user risk rising above a maximum threshold and/or a metric determining acceptability of right-of-way assertions falling below a minimum threshold.

Additionally or alternatively, the simulator may itself generate a hypothesis on the cause of an issue faced by the planning system and/or a bug encountered while troubleshooting a new version of the control parameters of the planning system, and recommend an update to the control parameters. As in the example above, this hypothesis may relate to the weighting of the right-of-way assertion and may be based on one or more autonomous vehicle metrics. Generation of a hypothesis or a solution in the form of updated parameters may involve applying one or more machine learning techniques to analyze the plurality of autonomous vehicle metrics alongside the existing planning system control parameters. For example, a machine learning model may take as an input a training dataset with control parameter data associated with autonomous vehicle metrics that have been deemed satisfactory, and control parameter data that caused one or more identified issues reflected in at least one autonomous vehicle metric. By training the model to understand the relation between control parameter values and/or weightings and autonomous vehicle metric values, the simulator may generate one or more updates to resolve issues in novel planning system datasets.

In some implementations, at step 340, the user may implement the update to the control parameters recommended by the simulator and confirm, via the user interface, that the update resolved the issue as described above. In other implementations, at step 340, the simulator may itself implement the recommended update to the control parameters and at step 350, output a plurality of updated autonomous vehicle metrics. The simulator may then confirm, at step 360, that the issue has been resolved. For example, this determination may be based on a finding that a condition has been satisfied and/or that a threshold has been met based on the updated plurality of metrics.

At step 370, if a user has generated a modified set of planning system control parameters, and if the user has at step 360 optionally determined the updated parameters are satisfactory, the user may deploy the one or more updated parameters to the planning systems of one or more autonomous vehicles, thereby resolving identified issues and/or improving the operation of the planning systems. Additionally or alternatively, as discussed above, the simulator itself may generate the modified set of control parameters and/or implement the modified set, confirming that the updated parameters are satisfactory. In some implementations, at step 370, the simulator may automatically deploy the updated set of parameters to the physical planning systems of one or more autonomous vehicles. The updated planning systems of the one or more autonomous vehicles may then be used by said vehicles for vehicle system control in future use cases.

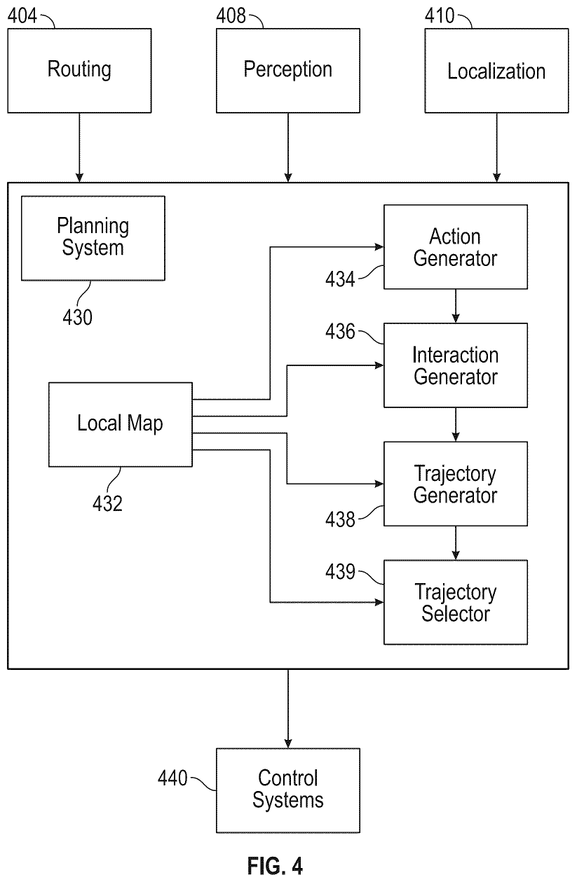

FIG. 4 depicts an exemplary flowchart involving the planning system of an autonomous vehicle, including inputs used and outputs genrated. As discussed above, planning system 430 may be located on the local computing system of an autonomous vehicle. Planning system 430 may execute on a cyclic basis, storing provided inputs and/or the state of one or more vehicle systems in an event log and generating one or more decisions or other outputs at a particular planning cycle frequency, for example 10 times every second. With each cycle, planning system 430 may receive inputs from one or more vehicle systems that may include, for example, routing 404, perception 408, and/or localization 410. The routing system 404 may define the route the autonomous vehicle must take to reach its destination, for example including turn-by-turn directions and/or choices of roadways. The perception system 408 may use optical, LiDAR, and/or radar sensors to detect and/or classify environmental objects, for example proximate vehicles, pedestrians, and/or lane markings. The localization system 410 may use GPS and/or IMU sensors to determine a precise position of the vehicle on a map. Planning system 430 may apply control logic to these input data to output a set of one or more decisions that, in the autonomous vehicle context, may command one or more low-level vehicle control systems 440 including, for example, steering, acceleration, braking, and/or lighting. In the semi-autonomous vehicle context, these one or more decisions may additionally or alternatively take the form of recommendations to the driver to implement the changes in vehicle operation.

The control logic that planning system 430 uses to cyclically output one or more decisions may be based on control system parameters as described above. Specifically, planning system 430 control logic may involve first building a local map or environmental model based on the provided input data. This map may include one or more objects surrounding the vehicle including static objects such as lane markings and/or traffic signs, dynamic objects such as proximate vehicles and/or pedestrians, traffic rules that apply to a particular, and/or environmental conditions such as evidence of precipitation on the road surface. The control logic may use information from the local map as an input to one or more decisional processes including, for example, an action generator 434, an interaction generator 436, a trajectory generator 438, and/or a trajectory selector 439.

Action generator 434 may determine candidate actions or vehicle behaviors based on the local map. Such candidate actions may include, for example, a velocity modification and/or a lane change. Candidate actions produced by action generator 434 may include “stop at pedestrian intersection” and/or “increase velocity to 75 MPH.” Interaction generator 436 may model interactions between the autonomous vehicle and other dynamic roadway objects and/or actors such as proximate vehicles and/or pedestrians. Interaction generator 436 may first model how the objects and/or actors will move then use this model in combination with known traffic rules in local map 432 to determine how the autonomous vehicle could respond. For example, interaction generator may determine whether a nearby vehicle will yield or continue at a roundabout and may validate that candidate actions generated by action generator 434 will maintain the safety of the vehicle and nearby vehicles and/or actors in light of this determination.

Trajectory generator 438 may use candidate actions from action generator 434 and modeled interactions from interaction generator 436 and convert them to executable candidate trajectories that prescribe a precise path and velocity profile for the autonomous vehicle to follow. The prescribed path and/or velocity profile of each candidate trajectory may be based on roadway information, proximate roadway actors, traffic rule information, variables such as stopping distance of the autonomous vehicle and/or proximate vehicles, and safety objective such as maintaining a set distance from proximate roadway actors. Trajectory selector 439 may then evaluate multiple candidate trajectories and select an optimal one by considering objectives such as safety, time efficiency, fuel efficiency, and/or smooth acceleration and/or deceleration.

In this way, trajectory selector 439 may consider information from action generator 434, interaction generator 436, trajectory generator 439. When used in combination with one another, action generator 434, interaction generator 436, trajectory generator 439, and trajectory selector 439 may form a “trajectory planner.” Such a trajectory planner may use as an input scene data associated with a single trajectory planning cycle and may first generate one or more candidate actions for execution by the autonomous vehicle using, for example, action generator 434. The trajectory planner may next model interactions between the vehicle and dynamic roadway actors to better predict their future behavior using, for example, interaction generator 436. The planner may next generate one or more candidate trajectories based on the one or more candidate actions generated by action generator 434 and/or on interaction models generated by interaction generator 436 using, for example, trajectory generator 436. The planner may next select an optimal trajectory from amongst the one or more candidate trajectories based on the one or more autonomous vehicle objectives discussed above using, for example, trajectory selector 439.

Once the optimal trajectory of the planning cycle has been selected, planning system 430 may next output one or more decisions to the autonomous vehicle's low-level control systems, for example, steering, throttle, and/or braking, and/or as recommendations for the driver of a semi-autonomous vehicle to implement. For example, as discussed above, planning system 430 may output a decision in the form of a control system command, sent to the steering system including, for example, “rotate the steering wheel by 5% to the left for two seconds.” Once planning cycle 430 outputs one or more decisions, the planning cycle may complete, and data associated with the planning cycle may be stored in an event log.

Stored data may include values used as inputs by the planning system, signal values corresponding to the state of the vehicle, weightings and/or parameters used by the planning system to produce one or more decisions, and the one or more decisions including commands and/or recommendations produced by the planning system for that cycle.

In simulating planning system 430, a simulation generated by a planning system simulator may take as an input scene data that may contain inputs similar to those from systems such as routing 404, perception 408, and/or localization 410, and use along with one or more additional inputs to generate a simulation of local map 432. The planning system simulation may then simulate action generator 434, interaction generator 436, trajectory generator 438, and/or trajectory selector 439. The simulation may further simulate the decisions generated as outputs in the form of commands for control system 440 and/or recommendations for a semi-autonomous vehicle driver. The simulation may additionally output a plurality of autonomous vehicle metrics as an indication of the control logic used to select a trajectory from a set of one or more candidate trajectories. As discussed above, such simulation may enable debugging or triaging of issues with the planning system of a physical autonomous vehicle and/or may enable regression testing or validation of new versions of planning system control parameters. The results of the simulation, and the graphical user interface discussed below, may enable a user to pinpoint where in the planning system process an error occurred, for example in action generator 434 and not in interaction generator 436.

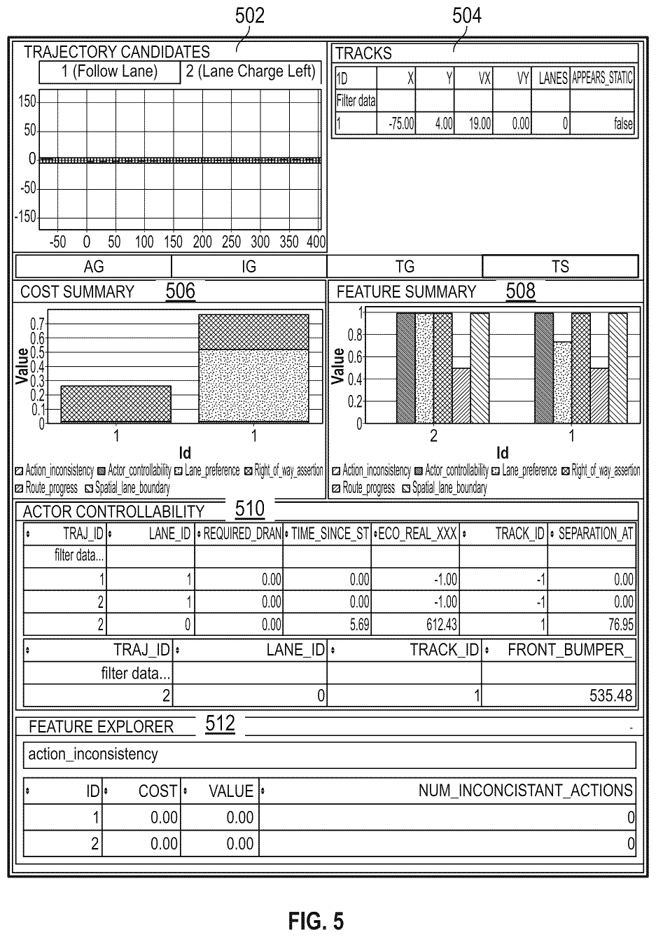

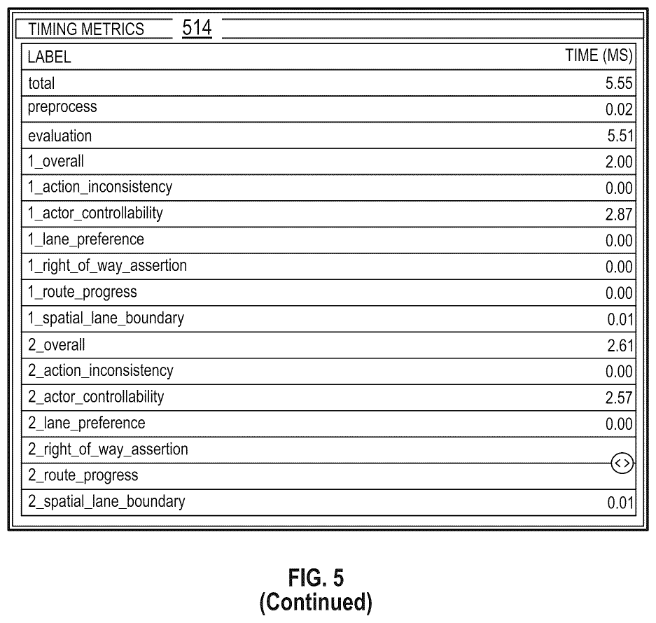

FIG. 5-7 depict exemplary graphical user interface views associated with the simulator, displaying a plurality of autonomous vehicle metrics associated with one or more candidate trajectories generated by the simulation of the planning system. Such user interfaces may be used by a user of the simulator to confirm or validate an issue with the planning system that a physical autonomous vehicle experienced. Alternatively or additionally, such interface may be used to evaluate whether updates to one or more parameters of the simulation, for example control parameters of the simulated planning system, had the intended effect. That is, to evaluate whether the updated parameters resolved an issue with the planning system of a physical autonomous vehicle and/or did not introduce new issues. In both cases, a user may use the interface to visualize outputs of the simulated planning system in the form of decisions such as low-level vehicle control system commands and/or driver recommendations and the control logic used to form them. These evaluations may correspond to step 360 of the process depicted in FIG. 3 involving a determination that a condition has been satisfied, for example via the correction of a failure condition and/or via the determination that at least one metric meets a threshold value. Visualizations may be based on data output by the planning system simulation for the purpose of visualization, for example a file containing scene metrics and/or metadata, optionally using the “parquet” file extension, and logged vehicle data that may be necessary to generate visualizations.

As discussed in the context of FIG. 3, the planning system simulator may extract data associated with a single planning cycle from the event log of a planning system that is associated with an event of interest based on user input and/or a detection of an event of interest. This extracted event log data may form scene data used by the planning system as an input. Additionally or alternatively scene data may be generated based on a scene data simulation and/or extracted from the event log of a multi-cycle planning system simulation. The scene data may thus represent planning system inputs and/or the state of the vehicle associated with that particular planning cycle and the particular environmental situation the vehicle was facing at the moment associated with the planning cycle.

To study the effect of modifications to different parameters of the simulated planning system, the simulator user interface may include multiple modes, including at least a scene mode and a batch mode. As discussed below, scene mode may enable visualization of the inputs and/or environmental conditions associated with the scene data of the single planning cycle modeled by the simulation. Batch mode be based on two or more variations on a scene that an autonomous vehicle may face, each based on a unique set of scene parameters and generated by the scene data simulation. Variations may include the number of vehicles proximate to the autonomous vehicle, the velocity and/or distance from the autonomous vehicle of each, and/or the type of intersection and/or merge scenario facing the autonomous vehicle. Each variation may thus correspond to a different instance of scene data, and involve the simulation running multiple times, once for each variation.

In scene mode, in the case of a simulation of a planning system forming a trajectory planner, the simulator user interface may include a plurality of scene views or scenario views. For example, as shown in FIG. 5, the interface may display at plot 502 the local map of the simulated planning system for each candidate trajectory, for example including inputs from the routing, perception, and localization systems. A tab selection at the top allows the user to switch between the candidate trajectory displayed on the local map plot, with the blue line indicating the trajectory on the road. The interface may also include at table 504 data associated with the vehicle's track, for example measured variables such as position and velocity of the autonomous vehicle in the recent past.

At bar chart 506, the simulator may display for each candidate trajectory autonomous vehicle metrics corresponding to a cost or risk associated with selecting a candidate trajectory. For example, selecting either candidate trajectory corresponds to some amount of cost related to right-of-way assertion, while selecting the candidate trajectory displayed to the right additionally entails cost related to lane preference that the candidate trajectory displayed to the left does not entail. A user may interpret bar chart 506 to mean that regardless of the trajectory selected, there is some risk associated with the planning system commanding or recommending the autonomous vehicle assert its right-of-way against proximate vehicles. A user may additionally understand from the bar chart that candidate trajectory displayed to the right may result in the vehicle entering a lane that corresponds to less safe or less efficient travel relative to the expected or ideal lane. Thus, displayed costs may represent the difference between metric values associated with a candidate trajectory and expected autonomous vehicle metric values.

Normalized values associated with multiple autonomous metrics may be displayed at bar chart 508, revealing in this case that between the candidate trajectories all plotted metrics except a lane preference metric are equivalent. In some implementations, bar charts 506 and/or 508 may include a selectable trajectory selection affordance that enables the user to select one or more candidate trajectories to display further information about the one or more selected candidate trajectories. In some implementations, this information may include, as in bar chart 506, a visualization of a cost associated with each of the one or more selected candidate trajectories. For example, as discussed above, the costs displayed may correspond to differences between metrics of candidate trajectories and expected or ideal metrics. In other implementations, this information may include, as in bar chart 508, at least a portion of the autonomous vehicle metrics for the one or more selected candidate trajectories.

Additional displays shown on the interface depicted in FIG. 5 include information related to actor controllability metrics at table 510, information related to various features selected from a drop-down menu at table 512, and information related to the time it took the planning system simulation to run the model of the single cycle at table 514, including the time to generate values associated with a plurality of metrics for each candidate trajectory. The user interface may also include an indication of which trajectory the simulated planning system and specifically the simulated trajectory selector selected, for example based on a cost comparison such as the one shown in bar chart 506, and/or the weight values the simulated control logic placed on one or more of the autonomous vehicle metrics during selection.

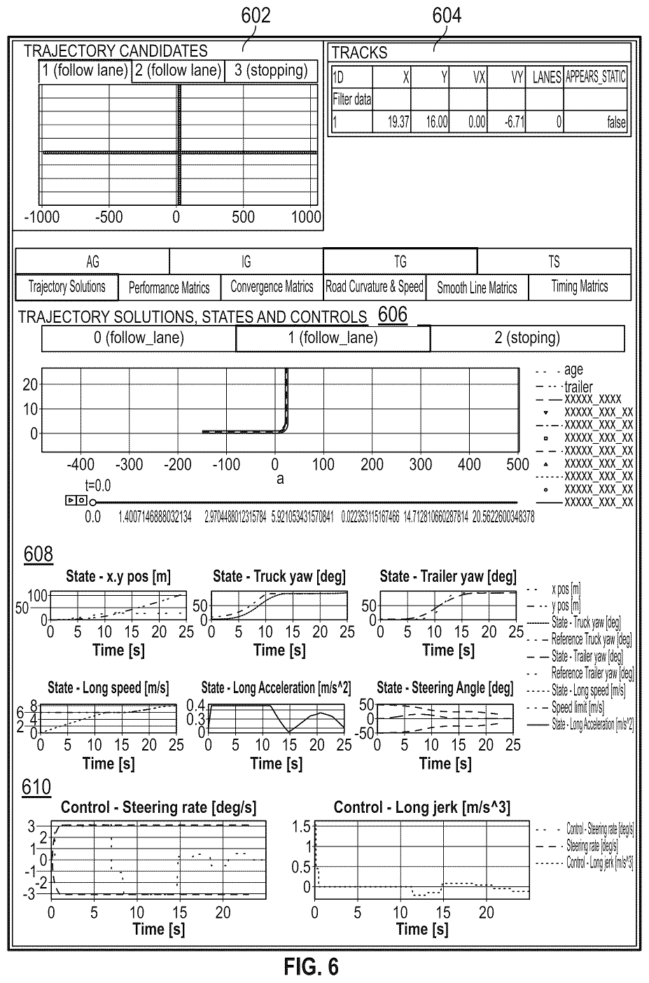

FIG. 6 depicts different environmental conditions: here, at plot 602, the local map comprises an intersection between two roadways with candidate trajectories varying as a function of the autonomous vehicle's response to the intersection. Here again a table 604 may display track information associated with the vehicle. A plot 606 may be used to compare a candidate trajectory to a hypothetical trajectory with limited acceleration and deceleration so as to evaluate the candidate trajectory's smoothness, corresponding to action inconsistency metrics. At display 608, the simulator may create multiple plots that display change in several vehicle states over time, for example position, yaw angle, velocity, acceleration, and/or steering angle. Such plots may include time periods beyond that of the modeled planning cycle, with state values over this time period based on the projected response to each candidate trajectory's prescription for vehicle motion. At display 610, the simulator may create multiple plots that display the planning system's commands to low-level vehicle systems corresponding to each candidate trajectory. For example, plots may include the rate of change of the steering and/or the rate of change of acceleration commanded by the planning system in response to the scene data input.

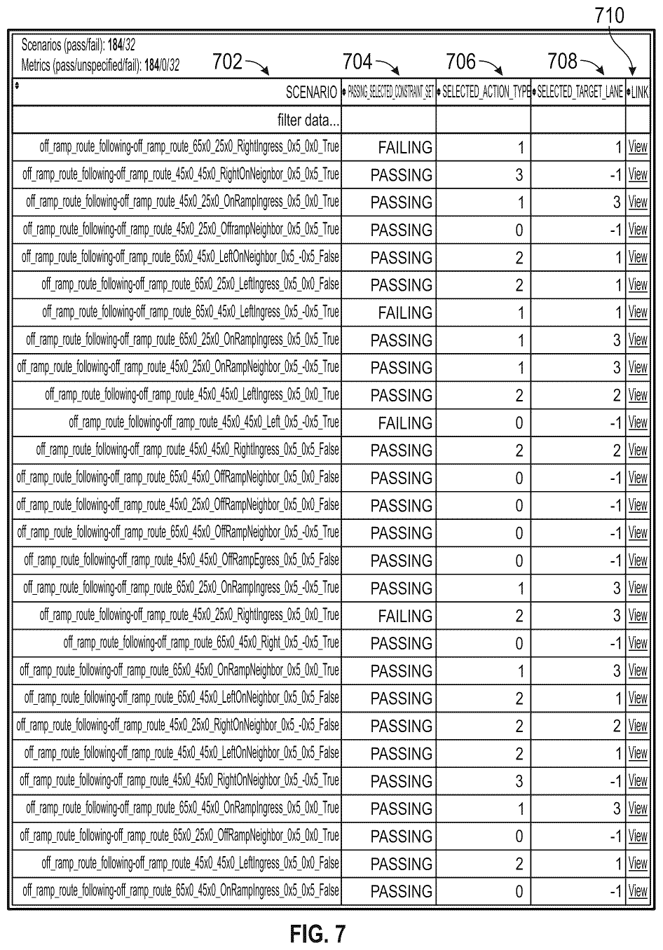

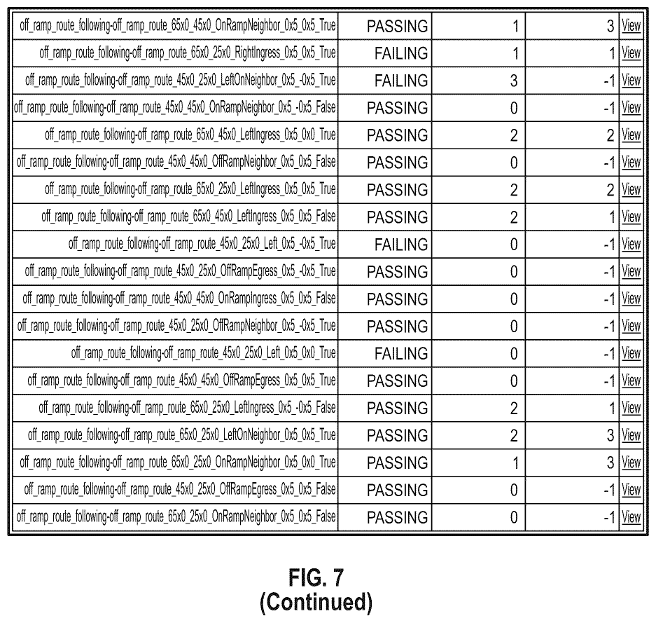

In batch mode, the simulation may have run multiple times, each time based on different scene data. Each variation may thus correspond to, for example, a set of decisions or trajectories, each with a corresponding set of autonomous vehicle metrics. For example, a user may choose to vary the velocity of a proximate vehicle from a relatively low value to a relatively high value, thereby increasing the risk of collision. The scene data variations may include subtle changes to a particular variable, as in the aforementioned example, or may involve a sampling of a set of common scenarios that an autonomous vehicle is likely to face, to understand how the planning system typically responds. In batch mode the simulator may create one or more batch views in the form of visualizations and data summaries to help the user understand the response of the simulated planning system to each scene data variant. For example, as shown in FIG. 7, a table may be created wherein, for each variation or scenario 702 generated by the scene data simulation, a first variable 704 may be included indicating whether the planning system output was passing or failing relative to a particular set of constraints. This set of constraints may be selected by the user using a selectable affordance and may include one or more autonomous vehicle metrics and/or other autonomous vehicle-related constraints. A separate selectable affordance may enable the user to select variations or scenarios for inclusion in the batch view. Whether a particular scenario corresponds to a passing or failing value for a particular constraint or set of constraints may be determined by whether the value associated with the one or more constraints meets a threshold value and/or whether a failure condition has been corrected. For example, if a value associated with a scenario and corresponding to action inconsistency falls below a threshold value, thereby meeting the threshold value, and/or if the planning system output associated with the scenario satisfied one or more other determiners of consistency, the value for that scenario may be displayed as passing.

Additionally, a second variable 706 may be included indicating a selected action type, for example reducing velocity or executing a turn. A third variable 708 may indicate the lane the planning cycle selected for the vehicle to travel in, and a fourth variable 710 may include a link to a view corresponding to each variation or scenario 702. Such a scenario view may, as in FIGS. 5 and 6 display, for example, one or more autonomous vehicle metrics corresponding to the scenario and/or costs associated with the one or more autonomous vehicle metrics of choosing one trajectory over another. For example, to visualize a lane preference metric, first variable 704 may indicate for each scenario 702 whether the planning system output would result in the vehicle preferring and occupying the most efficient and safest lane, with a “passing” value indicating that it would and a “failing” value indicating that it would not. In this example, a second variable 706 may indicate a corresponding vehicle action and third variable 708 may indicate a corresponding vehicle lane generated by the planning system for each variation or scenario 702. Fourth variable 710 may include a link to a scenario view for each variation or scenario.

Thus, a user may, for example, select “failing” scenarios for further investigation. For example, the user may use the link associated with one or more of the failing scenarios to view the scene view or scenario view associated with the failing scenario to better determine and address the cause of the planning system's failure to meet the user's expectation. The table displayed in FIG. 7 may be filtered and/or sorted in alphabetical order, or in ascending or descending order based on variables such as 704, 706, 708, and/or similar variables. The planning system simulator may also enable data in the table to be exported to other data formats for further visualization and analysis including CSV, JSON, XML, and/or XLSX.

Alternatively or additionally, one or more other visualizations may be generated by the simulator in batch mode. For example, the simulator may enable the user to create a bar chart and/or scatter plot indicating how values associated with one or more autonomous vehicle metrics vary as a function of the variations or scenarios generated by the scene data simulation and included in the batch. As above, the one or more autonomous vehicle metrics may be selected using a selectable affordance and a separate selectable affordance may enable the user to select variations or scenarios for inclusion in the batch view. In some implementations, to visualize action inconsistency, the simulator may create a plot displaying a factor that corresponds to the smoothness of the vehicles acceleration or deceleration across various scenarios or scenes. In other implementations, the simulator may create a plot displaying the risk of collision with a particular proximate vehicle in a particular scene wherein each scene variation represents a slight change to the autonomous vehicle's velocity and/or prioritization of braking other collision avoidance mechanisms. A user may use the resulting plot to determine whether changes to control parameters that result in a lower vehicle velocity in similar scenarios and/or a higher weighting or prioritization on generation of braking commands by the planning system may be warranted to reduce the future risk of collision.

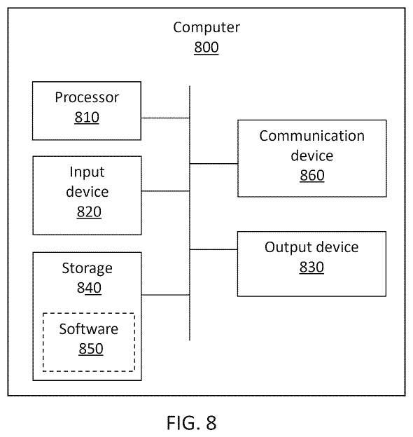

In one or more examples, the disclosed systems and methods utilize or may include a computer system. FIG. 8 depicts an exemplary computing system according to one or more examples of the disclosure. Computer 800 can be a host computer connected to a network. Computer 800 can be a client computer or a server. As shown in FIG. 8, computer 800 can be any suitable type of microprocessor-based device, such as a personal computer, workstation, server, or handheld computing device, such as a phone or tablet. The computer can include, for example, one or more of processor 810, input device 820, output device 830, storage 840, and communication device 860. Input device 820 and output device 830 can correspond to those described above and can either be connectable or integrated with the computer.

Input device 820 can be any suitable device that provides input, such as a touch screen or monitor, keyboard, mouse, or voice-recognition device. Output device 830 can be any suitable device that provides an output, such as a touch screen, monitor, printer, disk drive, or speaker.

Storage 840 can be any suitable device that provides storage, such as an electrical, magnetic, or optical memory, including a random-access memory (RAM), cache, hard drive, CD-ROM drive, tape drive, or removable storage disk. Communication device 860 can include any suitable device capable of transmitting and receiving signals over a network, such as a network interface chip or card. The components of the computer can be connected in any suitable manner, such as via a physical bus or wirelessly. Storage 840 can be a non-transitory computer-readable storage medium comprising one or more programs, which, when executed by one or more processors, such as processor 810, cause the one or more processors to execute methods described herein.

Software 850, which can be stored in storage 840 and executed by processor 810, can include, for example, the programming that embodies the functionality of the present disclosure (e.g., as embodied in the systems, computers, servers, and/or devices as described above). In one or more examples, software 850 can include a combination of servers such as application servers and database servers.

Software 850 can also be stored and/or transported within any computer-readable storage medium for use by or in connection with an instruction execution system, apparatus, or device, such as those detailed above, that can fetch and execute instructions associated with the software from the instruction execution system, apparatus, or device. In the context of this disclosure, a computer-readable storage medium can be any medium, such as storage 840, that can contain or store programming for use by or in connection with an instruction execution system, apparatus, or device.

Software 850 can also be propagated within any transport medium for use by or in connection with an instruction execution system, apparatus, or device, such as those described above, that can fetch and execute instructions associated with the software from the instruction execution system, apparatus, or device. In the context of this disclosure, a transport medium can be any medium that can communicate, propagate, or transport programming for use by or in connection with an instruction execution system, apparatus, or device. The transport-readable medium can include but is not limited to, an electronic, magnetic, optical, electromagnetic, or infrared wired or wireless propagation medium.

Computer 800 may be connected to a network, which can be any suitable type of interconnected communication system. The network can implement any suitable communications protocol and can be secured by any suitable security protocol. The network can comprise network links of any suitable arrangement that can implement the transmission and reception of network signals, such as wireless network connections, T1 or T3 lines, cable networks, DSL, or telephone lines.

Computer 800 can implement any operating system suitable for operating on the network. Software 850 can be written in any suitable programming language, such as C, C++, Java, or Python. In various embodiments, application software embodying the functionality of the present disclosure can be deployed in different configurations, such as in a client/server arrangement or through a Web browser as a Web-based application or Web service, for example.

The foregoing description, for the purpose of explanation, has been described with reference to specific embodiments and/or examples. However, the illustrative discussions above are not intended to be exhaustive or to limit the invention to the precise forms disclosed. Many modifications and variations are possible in view of the above teachings. The embodiments were chosen and described in order to best explain the principles of the techniques and their practical applications. Others skilled in the art are thereby enabled to best utilize the techniques and various embodiments with various modifications as are suited to the particular use contemplated.

1. A method for updating a planning system of an autonomous vehicle, the method comprising:
obtaining, at a simulator, an input comprising scene data associated with a single planning cycle of the planning system;
using the simulator, apply a simulation of the planning system based on the scene data to output a plurality of autonomous vehicle metrics;
updating one or more parameters of the simulation based on the plurality of autonomous vehicle metrics;
outputting a plurality of updated autonomous vehicle metrics based on the one or more updated parameters;
determining that a condition is satisfied based on the plurality of updated autonomous vehicle metrics; and
deploying the one or more updated parameters to the planning system of the autonomous vehicle.

2. The method of claim 1, wherein updating the planning system comprises updating a trajectory planner of the planning system and the input comprises scene data associated with a single trajectory planning cycle of the trajectory planner.

3. The method of claim 1, wherein the simulation of the planning system is based only on the scene data associated with the single planning cycle.

4. The method of claim 1, wherein the planning system is configured to complete ten cycles per second.

5. The method of claim 1, wherein the scene data associated with the single planning cycle is extracted from one or more event logs of the planning system.

6. The method of claim 5, wherein the scene data is extracted from the one or more event logs based on at least one of a user input comprising an indication of an event or a detection by the planning system of an event.

7. The method of claim 6, wherein the scene data comprises input data associated with the event and used by the planning system during the single planning cycle.

8. The method of claim 7, wherein the input data comprises at least one of perception data, localization data, or routing data.

9. The method of claim 8, wherein the perception data is detected by one or more perception sensors positioned on the autonomous vehicle.

10. The method of claim 1, wherein the scene data associated with the single planning cycle is extracted from one or more event logs of a multi-cycle planning system simulation.

11. The method of claim 1, wherein the scene data associated with the single planning cycle is generated by a scene data simulation.

12. The method of claim 11, wherein generating the scene data comprises generating a plurality of variations of a scene, wherein each variation is generated based on a unique set of scene parameters.

13. The method of claim 1, wherein the portion of the plurality of autonomous vehicle metrics comprise at least one of: one or more action inconsistency metrics, one or more actor controllability metrics, one or more lane preference metrics, one or more right-of-way assertion metrics, one or more route progress metrics, or one or more spatial lane boundary metrics.

14. The method of claim 1, wherein determining that the condition is satisfied comprises at least one of:
determining, based on the plurality of updated autonomous vehicle metrics, that a failure condition has been corrected; or
determining that at least one of the plurality of updated autonomous vehicle metrics meets a threshold value.

15. The method of claim 1, wherein the single planning cycle comprises:
a trajectory generation step comprising generating one or more candidate trajectories based on one or more candidate actions; and
a trajectory selection step comprising selecting a candidate trajectory from the one or more candidate trajectories.

16. The method of claim 15, wherein the single planning cycle further comprises, prior to the trajectory generation step:
an action generation step comprising generating the one or more candidate actions for execution by the autonomous vehicle; and
an interaction generation step comprising validating the one or more candidate actions based on a model of one or more interactions between the autonomous vehicle and a vehicle nearby to the autonomous vehicle.

17. The method of claim 1, further comprising displaying a graphical user interface, wherein the graphical user interface comprises a visualization of at least a portion of the plurality of autonomous vehicle metrics.

18. The method of claim 17, further comprising:
detecting, at the graphical user interface, a user input indicating a selection of a selectable trajectory selection affordance; and
causing, in response to detecting the user input, the graphical user interface to display at least a portion of the plurality of autonomous vehicle metrics for one or more candidate trajectories.

19. The method of claim 18, further comprising causing, in response to detecting the user input, the graphical user interface to display a visualization of a cost associated with the one or more candidate trajectories.

20. The method of claim 19, wherein the cost is determined based on a difference between the autonomous vehicle metrics associated with a candidate trajectory and expected autonomous vehicle metrics.

21. The method of claim 17, wherein the graphical user interface comprises a batch view comprising a selectable first affordance, the method further comprising:
detecting, at the graphical user interface, a user input indicating a selection of the selectable first affordance; and
causing, in response to detecting the user input, the graphical user interface to display at least a portion of the plurality of autonomous vehicle metrics associated with a plurality of variations of a scene generated by a scene data simulation.

22. The method of claim 21, wherein the portion of the plurality of autonomous vehicle metrics comprise an indication of whether each variation of the plurality of variations passed or failed a selected constraint set.

23. The method of claim 21, wherein the portion of the plurality of autonomous vehicle metrics comprise an indication of a selected action type for each variation of the plurality of variations.

24. The method of claim 21, wherein the batch view comprises a selectable second affordance associated with the plurality of variations, the method further comprising:
detecting, at the graphical user interface, a user input indicating a selection of a variation of the plurality of variations using the selectable second affordance; and
causing, in response to detecting the user input, the graphical user interface to display at least a portion of the plurality of autonomous vehicle metrics associated with the selected variation.

25. A system for updating a planning system of an autonomous vehicle, the system comprising one or more processors and memory storing instructions that, when executed by the one or more processors, cause the system to:
obtain, at a simulator, an input comprising scene data associated with a single planning cycle of the planning system;
apply, using the simulator, a simulation of the planning system based on the scene data to output a plurality of autonomous vehicle metrics;
update one or more parameters of the simulation based on the plurality of autonomous vehicle metrics;
output a plurality of updated autonomous vehicle metrics based on the one or more updated parameters;
determine that a condition is satisfied based on the plurality of updated autonomous vehicle metrics; and
deploy the one or more updated parameters to the planning system of the autonomous vehicle.

26. A non-transitory computer readable storage medium storing instructions for updating a planning system of an autonomous vehicle, wherein the instructions, when executed by one or more processors of an electronic device, cause the device to:
obtain, at a simulator, an input comprising scene data associated with a single planning cycle of the planning system;
apply, using the simulator, a simulation of the planning system based on the scene data to output a plurality of autonomous vehicle metrics;
update one or more parameters of the simulation based on the plurality of autonomous vehicle metrics;
output a plurality of updated autonomous vehicle metrics based on the one or more updated parameters;
determine that a condition is satisfied based on the plurality of updated autonomous vehicle metrics; and
deploy the one or more updated parameters to the planning system of the autonomous vehicle.
